(19) United States
(12) Patent Application Publication
(10) Pub. No.: US 2024/0273470 A1
(43) Pub. Date: Aug. 15, 2024

(54) CUSTOMER MATCHMAKING FOR MANAGED SERVICE PROVIDERS AS A SERVICE LEVERAGING SYSTEMS PROVIDING ACCESS MANAGEMENT AS A SERVICE

(71) Applicant: Pax8, Inc., Greenwood Village, CO (US)

(72) Inventors: Scott Chasin, Denver, CO (US); Connor Slagle, Colorado Springs, CO (US); Jason Bello, Colorado Springs, CO (US); Christopher Bynum, Colorado Springs, CO (US); Mark Michelman, Colorado Springs, CO (US)

(21) Appl. No.: 18/108,652

(22) Filed: Feb. 12, 2023

(51) Int. Cl. G06Q 10/1053; G06N 20/00

(52) U.S. Cl. CPC G06Q 10/1053; G06N 20/00

(57) ABSTRACT

A system and method for providing access to third-party software tools as a service. In particular, a service access manager can communicate with one or more third parties to obtain data about licensing and usage of one or more third-party software tools. Retrieved data can be used to match an organization seeking to engage a managed service provider for management of one or more third-party software tools with a suitable managed service provider for doing so.

### TECHNICAL FIELD

Embodiments described herein relate to data and service access management systems, and, in particular, to systems and methods for leveraging a data and service access management system architecture to provide matchmaking between organizations and managed service providers (MSPs) as a service.

### BACKGROUND

An organization may provide its employees with access to one or more software tools to facilitate collaboration and completion of work. In lieu of developing in-house software tools and services, a typical organization licenses access for its employees to various third-party software tools and services, such as email services, document storage systems, office suites, design platforms, and so on. To simplify business operations, many organizations (especially small and medium-sized businesses) engage an MSP to administer, support, and provide access to third-party software tools from one or more third-party software vendors.

However, some MSPs may be better suited to support certain organizations or types of organizations than others. For example, certain MSPs may be accustomed to dealing with organizations of a certain size, may be more familiar with administering, supporting, and providing access to some third party software tools but not others, or the like. Organizations engaging an MSP may not be aware of the various competencies of the MSP at the time of engagement. In some cases, this may result in inefficiencies for both the organization and the MSP. For example, an organization may need to expend resources to ensure the MSP is capable of meeting its needs. As another example, an MSP may need to expend resources to support new third party software tools that it has no experience with, while an organization may experience inefficient management of its third party software tools by the MSP.

### SUMMARY

Embodiments described herein relate to leveraging the information obtained from operation of an access management system to match MSPs to customers seeking to engage MSPs for the management of third-party software tools. In one embodiment, a server system includes a memory resource and a processing resource. The processing resource may be intercoupled with the memory resource and configured to instantiate an instance of software.

The software may be configured to collect and store software licensing information and generate training data for a machine learning model from the software licensing management information. The software licensing management information may include information about each of a set of MSPs and information about each of a set of customers of each of the set of MSPs. The information about each of the set of customers may include a set of third-party software licensed by and deployed by the customer.

The training data may be configured to cause a machine learning model trained using the training data to receive information about an organization seeking to engage an MSP to manage third-party software for the organization as an input and provide an MSP of the set of MSPs to manage the third-party software of the organization as an output.

In one embodiment, the software licensing information is collected, at least in part, from one or more third-party application programming interfaces.

In one embodiment, collecting and storing the software licensing management information includes providing an application programming interface endpoint for communication with one or more third-party services and receiving at least a portion of the software licensing management information from the one or more third-party services via the application programming interface endpoint.

In one embodiment, the information about each of the set of customers includes one or more of a location of the customer, an industry associated with the customer, a revenue of the customer, a number of employees of the customer, an age of the customer, an information technology budget of the customer, and one or more types of electronic devices used by the customer.

In one embodiment, the information about the organization seeking to engage the MSP includes one or more of a location of the organization, an industry associated with the organization, a revenue of the organization, a number of employees of the organization, an age of the organization, an information technology budget of the organization, and one or more types of electronic devices used by the organization.

In one embodiment, the instance of software is further configured to train the machine learning model using the generated training data.

In one embodiment, training of the machine learning model is unsupervised.

In one embodiment, the generated training data for the machine learning model is unlabeled.

In one embodiment, a server system includes a memory resource and a processing resource. The processing resource may be intercoupled with the memory resource and configured to instantiate an instance of software. The software may be configured to collect and store software licensing information, receive information about an organization seeking to engage an MSP to manage third-party software for the organization, and select an MSP from a set of MSPs for managing the third-party software of the organization. The software licensing management information may include information about each of a set of MSPs and information about each of a set of customers of each of the set of MSPs. The information about each of the set of customers may include a set of third-party software licensed by and deployed by the customer. The selected MSP may be generated as an output of a machine learning model provided the information about the organization as an input. The machine learning model may be trained at least in part using training data generated from the software licensing management information.

In one embodiment, the software licensing information is collected, at least in part, from one or more third-party application programming interfaces.

In one embodiment, collecting and storing the software licensing management information includes providing an application programming interface endpoint for communication with one or more third-party services and receiving at least a portion of the software licensing management information from the one or more third-party services via the application programming interface endpoint.

In one embodiment, the information about each of the set of customers includes one or more of a location of the customer, an industry associated with the customer, a revenue of the customer, a number of employees of the customer, an age of the customer, an information technology budget of the customer, and one or more types of electronic devices used by the customer.

In one embodiment, the information about the organization seeking to engage the MSP includes one or more of a location of the organization, an industry associated with the organization, a revenue of the organization, a number of employees of the organization, an age of the organization, an information technology budget of the organization, and one or more types of electronic devices used by the organization.

In one embodiment, the instance of software is a backend application instance configured to communicably couple to a frontend application instance instantiated by a client device communicably coupled to the server system. The information about the organization may be received from the frontend application instance. The selected MSP may be provided to the frontend application instance to cause the frontend application instance to display, in a graphical user interface thereof, information about the selected MSP.

In one embodiment, a method for matching an organization to an MSP includes collecting and storing software licensing management information, receiving information about an organization seeking to engage an MSP to manage third-party software for the organization, selecting an MSP from a set of MSPs based on the information about the organization and the software licensing management information, and causing a graphical user interface to display information about the selected MSP. The software licensing management information may include information about each of a set of MSPs and information about each of a set of customers of each of the set of MSPs. The information about each of the set of customers may include a set of third-party software licensed by and deployed by the customer. The information about the organization may be received as a request from a frontend instance of software instantiated at a client device at a backend instance of software instantiated by cooperation of processing resources and memory resources. The selected MSP may be generated in response to the request, and may be provided as an output of a machine learning model provided the information about the organization as an input. The machine learning model may be trained at least in part using training data generated from the software licensing management information. The selected MSP may be provided to the frontend instance, where it causes a graphical user interface to display information about the MSP.

In one embodiment, the software licensing information is collected, at least in part, from one or more third-party application programming interfaces.

In one embodiment, collecting and storing the software licensing management information includes providing an application programming interface endpoint for communication with one or more third-party services and receiving at least a portion of the software licensing management information from the one or more third-party services via the application programming interface endpoint.

In one embodiment, the information about each of the set of customers includes one or more of a location of the customer, an industry associated with the customer, a revenue of the customer, a number of employees of the customer, an age of the customer, an information technology budget of the customer, and one or more types of electronic devices used by the customer.

In one embodiment, the information about the organization seeking to engage the MSP includes one or more of a location of the organization, an industry associated with the organization, a revenue of the organization, a number of employees of the organization, an age of the organization, an information technology budget of the organization, and one or more types of electronic devices used by the organization.

In one embodiment, the method further includes causing the graphical user interface of the frontend instance to display one or more graphical user elements for collecting the information about the organization and for initiating communication of the information about the organization to the backend instance.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system for providing access management as a service, such as described herein.

FIG. 2 depicts a system diagram of a system configured to facilitate matchmaking between an organization seeking to engage an MSP for management of one or more third-party software tools and an MSP for managing the one or more third-party software tools.

FIG. 3 depicts an alternative system diagram of a system configured to facilitate matchmaking between an organization seeking to engage an MSP for management of one or more third-party software tools and an MSP for managing the one or more third-party software tools.

FIGS. 4A-4B depict a client device executing an instance of a client application rendering a graphical user interface of a system configured to facilitate matchmaking between an organization seeking to engage an MSP for management of one or more third-party software tools and an MSP for managing the one or more third-party software tools.

FIG. 5 is a flowchart depicting example operations of a method for matching an organization seeking to engage an MSP for management of one or more third-party software tools and an MSP for managing the one or more third-party software tools.

FIG. 6 is a flowchart depicting example operations of a method for matching an organization seeking to engage an MSP for management of one or more third-party software tools and an MSP for managing the one or more third-party software tools.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to computing systems, computer architectures, and computer-implemented methods configured to provide, control, and manage access to third-party software tools.

In particular, embodiments described herein relate to systems and methods that leverage such architectures, and data generated by and/or accessible as a result of such architectures, to provide matchmaking between organizations requiring management of one or more third-party software tools and MSPs to manage the one or more third-party software tools.

More specifically, a system described herein collects information from third-party software providers (either by accessing third-party software provider API endpoints or by providing an interface for communication with third-party software providers) to provide, control, and manage access to third-party software tools as a service. The information collected in the facilitation of this service may include information about how various organizations utilize various MSPs for the management of third-party software products. Accordingly, this information may be useful for matching organizations seeking to engage an MSP to an MSP suited to manage their third-party software products.

Embodiments described herein simplify MSP workflows by providing a centralized interface configured to manage different third-party software products and licensing structures for organizational clients of that MSP. The centralized interface may communicate with various third-party software management tools, either by communicating with multiple third-party software vendor APIs or by providing an interface by which third-party software vendors can communicate. An MSP can leverage such a system to simplify billing and license management for multiple small and medium-sized businesses (SMBs), which in turn can free up time and bandwidth for the MSP to service more organizational clients and/or to provide more hands-on support to existing clients.

Such a centralized system has many benefits beyond simplifying business operations for MSPs and/or reducing costs for MSPs and organizations alike. In particular, a centralized system providing, as a service, access to third-party data and third-party software services can be used to efficiently match organizations seeking to engage an MSP to an MSP suitable for managing the third-party software tools of the organization. In particular, as a result of the “access management as a service” architecture described herein, information and/or metadata generated in respect of a particular organization's use of third-party software tools and the MSP managing those third-party software tools may be used to match an organization with an MSP that can efficiently manage the third-party software tools for the organization. This may result in further simplification of business operations for MSPs and/or further reduced costs for MSPs and organizations alike.

As an example, a system described herein can quickly and efficiently enumerate the third-party software tools managed by an MSP on behalf of organizations engaging the MSP, and, in some cases, metrics about usage of third-party software tools managed by the MSP on behalf of organizations engaging the MSP (e.g., what devices, and versions thereof, are accessing which services).

The system may also keep track of information about each organization engaging the MSP, such as a size of the organization, a location or locations of the organization, the industry or industries in which the organization operates, a revenue of the organization, a number of employees of the organization, an information technology budget of the organization, a type or types of electronic devices used by employees of the organization, or any other information. Patterns may emerge in the above information, indicating, by way of example, that certain MSPs work primarily with organizations of a certain size, organizations within a certain industry, or with a certain set of third-party software tools. Accordingly, this information may be used to match organizations seeking to engage an MSP for the management of third-party software tools with an MSP qualified to do so.

More specifically, information about MSPs and the customers (i.e., organizations) engaging the MSPs, such as third-party software tools licensed by and deployed by the customers, may be used to generate training data for a machine learning model. The machine learning model may receive, as an input, information about an organization seeking to engage an MSP for the management of third-party software tools, and provide, as an output, a qualified MSP for managing the third-party software tools of the organization. The information about the organization can include, for example, a location of the organization, an industry or industries in which the organization operates, a revenue of the organization, a number of employees in the organization, an age of the organization, an information technology budget of the organization, a type or types of electronic devices used by the organization, one or more third-party software tools used by the organization, or any other information about the organization. Matching organizations to MSPs using the information obtained in the normal operation of the “access management as a service” architecture described herein may ensure that an MSP engaged by an organization is able to efficiently and competently manage the third-party software tools used by the organization, thereby simplifying business operations for MSPs and reducing costs for both MSPs and organizations engaging the MSPs.

In one example, a COMPANY may engage an MSP to obtain licensing to a cloud-based data storage system, an office suite, and one or more operating systems to be installed on personal computing devices such as COMPANY laptops. In response to the request from the COMPANY, the MSP can leverage an access management platform as described herein, which is configured to automatically obtain licensing from data storage system providers, office suite providers, and operating system providers.

The MSP can, through a user interface of the access management platform, select a bundle of products suitable for the COMPANY, which may be from three different software vendors. In response, the access management system can obtain the licenses (e.g., by generating requests to appropriate third-party software/service vendors so as to generate/provision appropriate software licenses) for the selected data storage system, the selected office suite, and the selected operating systems. Thereafter, the MSP may assist COMPANY with deploying such software.

Information obtained in the normal operation of the access management platform may indicate that the MSP primarily manages third-party software tools for small-sized businesses (e.g., businesses having less than 20 employees) in the software industry, and be experienced managing a particular set of third-party software. This MSP may therefore be under-resourced to deal with a medium-sized business (e.g., a business having more than 100 employees), or may lack certain expertise in the management of third-party software tools for a different industry, such as the manufacturing industry. Normally, the COMPANY would need to expend resources vetting the MSP to ensure that the MSP was capable of efficiently and competently managing the data storage system, the office suite, and the operating systems. Using the information generated as a result of the normal operation of the access management platform described herein may allow the COMPANY to match with an MSP suitable for managing their third-party software tools with minimal resource expenditure on their part. Similarly, MSPs receiving an inquiry from COMPANY would normally need to expend resources ensuring they had the expertise and resources to adequately service the needs of the COMPANY. Using the information generated as a result of the normal operation of the access management platform described herein may allow MSPs to match with organizations they are capable of efficiently and competently servicing with minimal resource expenditure on their part.

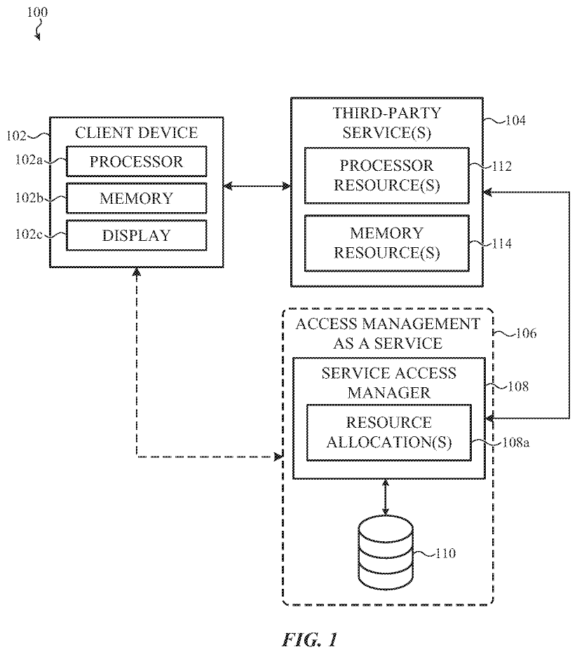

FIG. 1 depicts a system 100 for providing access management as a service, such as described herein. The system 100 can include, in a simplified architecture, and/or be defined by communications by and between, a client device 102, a third-party service 104, and an access management service 106.

The client device 102 can be any suitable electronic device. Examples include, but are not limited to, cellular phones, laptop computers, desktop computers, server computers, and so on. More generally, the client device 102 may be any electronic device or computing resource configured to communicably intercouple (e.g., via one or more networks) to one or more other electronic devices, such as a server computer executing an instance of a third-party service 104 or a server computer executing an instance of the access management service 106.

In some cases, the access management service 106 can be operated to, among other operations, request provisioning of licenses to access the third-party service 104 on behalf of a user of the client device 102. For example, the access management service 106 can be configured to leverage an API of the third-party service 104 to automatically request provisioning/issuance of one or more licenses to access the third-party service 104.

In many constructions the access management service 106 and the third-party service 104 are each implemented as instances of software executing over one or more virtual or physical resources associated with a cloud-based infrastructure, such as may be provided by a cloud services provider. In these embodiments, processing resources associated with, and/or allocated to, a particular server instance can cooperate with memory resources associated with the server instance to execute one or more computer readable instructions to instantiate an instance of software defining and/or implementing the third-party service 104 or the access management service 106.

More generally, although it may be appreciated that the third-party service 104 and the access management service 106 may be implemented in any number of ways and may be configured to communicate over a variety of protocols, in many embodiments each is implemented as a separate instance of cloud-based software supported by separate infrastructure.

It may be appreciated that the third-party service 104 can serve as a host of any suitable software product. Examples include, but are not limited to, email services, messaging services, instant messaging services, documentation services, office product services, word processing services, securing services, database services, design services, translation services, music and/or video production services, information technology infrastructure management services, and so on. These examples are not exhaustive.

As noted above, an access management service such as the access management service 106 can be configured to request and revoke software licenses to particular software products, such as to the third-party service 104. In addition, the access management service 106 can be configured to facilitate access to one or more functionalities of one or more third-party APIs (such as API endpoints provided by the third-party service 104). For example, the access management service 106 can be configured to access a license usage statistics API endpoint of a particular third-party API of the third-party service 104, or, in some embodiments, provide an interface by which the third-party service 104 can report license usage data to the access management service 106 (e.g., provide an API endpoint at which the third-party service 104 can report license usage data).

More particularly, the access management service 106 can include a service access manager 108 in communication with a database 110 storing information regarding how to interface with one or more third-party services. As a result of this construction, the service access manager 108 can be configured to access the database 110 to determine how to interface with one or more third-party services.

In some examples, the access management service 106 and/or the service access manager 108 can be leveraged by an MSP to generate invoices based on the use of the third-party service 104 by a user of the client device 102. In other cases, the access management service 106 and/or the service access manager 108 can be leveraged by an MSP to generate invoices based on the use of the third-party service 104 by an organization associated with the client device 102.

In other cases, the access management service 106 can be used by an MSP to support an organization's third-party licensing needs, such as described above. In addition, the access management service 106 can be used to aggregate and/or obtain information such as usage information and/or software configuration information that may be used to match an organization seeking an MSP to a compatible MSP, such as described above.

More specifically, as noted above, an organization may engage an MSP and/or a value-added reseller (VAR) to license access to, and/or actively administer, one or more third-party software tools, which may be referred to herein as “collaboration tools.” Example collaboration tools include email services, telephony services, instant messaging systems, documentation systems, word processing systems, information technology management systems, ticketing systems, issue tracking systems, incident response systems, software repositories, design platforms, video and/or audio production platforms, networking platforms, identity management systems, and so on. A person skilled in the art may appreciate that these example collaboration tools are not exhaustive of all types of software tools that may be licensed by an organization for use by one or more employees; an organization may license access to collaboration tools developed and maintained by different third-party software providers (herein, software “vendors”).

As an organization's collaboration tool library (and/or employee headcount) grow, licensing costs likewise increase as does the importance of active license management. Phrased in another manner, organizations and MSPs/VARs may often be tasked with regularly auditing whether licenses are actively being used to identify unused licenses that can be terminated. The access management service 106 may streamline these tasks, ensuring that the correct number of licenses for an organization are maintained over time.

As discussed above, the information collected in the regular course of providing the access management service 106 described above includes information about how various organizations engage various MSPs to manage the third-party software tools thereof. This information may include details about each organization (e.g., a location of the organization, an industry or industries in which the organization operates, a revenue of the organization, a number of employees in the organization, an age of the organization, an information technology budget of the organization, a type or types of electronic devices used by the organization, one or more third-party software tools used by the organization, or any other information about the organization). Information about MSPs may therefore be derived from the information, such as, for example, characteristics of the organizations an MSP normally services, the types of third-party software products the MSP normally supports, or any other information. Embodiments described herein leverage this information to match an organization seeking to engage an MSP to manage the third-party software tools thereof with an MSP qualified to efficiently do so, with minimal resource expenditure required from both the organization and the MSP.

In some cases, the access management service 106 may present a graphical user interface to collect information about an organization seeking to engage an MSP. The information about the organization may be provided, as an input, to a machine learning model trained using information collected in the regular course of providing the access management service 106, such as described above. The machine learning model may provide, as an output, an MSP or MSPs qualified to manage the third-party software tools of the organization. Details about the MSP or MSPs may then be displayed via the graphical user interface (e.g., contact information so that the organization may engage the MSP or MSPs).

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, the access management service 106 may use any suitable architecture for communicating with the third-party service 104. In one embodiment, custom functions are used to access third-party APIs, each of which is tailored to a particular third-party API or APIs. This may not be required if third-party software vendors implement common or industry-standard APIs. In some cases, a backend application instance may be configured to host an API or set of APIs that third-party vendors communicate with in order to communicate information relating to the licensing and/or usage of third-party software tools. In yet other examples, a monolithic, microservice, or hybrid architecture may be used. In short, the access management service 106 may provide the functionality described above in any suitable manner, and have any suitable system architecture.

Further, it may be appreciated that the client device 102 can be configured in any number of suitable ways. In one embodiment, the client device 102 is an electronic device that includes a processor 102a, a memory 102b, and a display 102c. The processor 102a and the memory 102b cooperate to instantiate an instance of software that can be configured to communicate with and/or exchange information with the service access manager 108 and/or the third-party service 104. In some examples, the instance of software may be referred to as a client application and/or frontend that corresponds to a backend instance operated at the third-party service 104 and/or the service access manager 108.

Similarly, the service access manager 108 may be one or more instances of software executing over one or more resource allocations 108a. The resource allocations 108a may be physical or virtual, and may be associated, for example, with a cloud-based infrastructure, such as may be provided by a cloud services provider. The resource allocations 108a may include processing resources cooperating with memory resources to execute one or more computer readable instructions to instantiate one or more instances of software defining and/or implementing the service access manager 108.

The third-party service 104 may similarly be one or more instances of software executing over one or more processor resources 112 in connection with one or more memory resources 114. The processor resources 112 and memory resources 114 may be physical or virtual, and may be associated, for example, with a cloud-based infrastructure, such as may be provided by a cloud services provider. Generally, the processor resources 112 and the memory resources 114 of the third-party service 104 are different from the resource allocations 108a of the service access manager 108, as the third-party service 104 and the service access manager 108 are different instances of software supported by separate infrastructure. The processor resources 112 may execute one or more computer readable instructions from the memory resources 114 to instantiate one or more instances of software defining and/or implementing the third-party service 104.

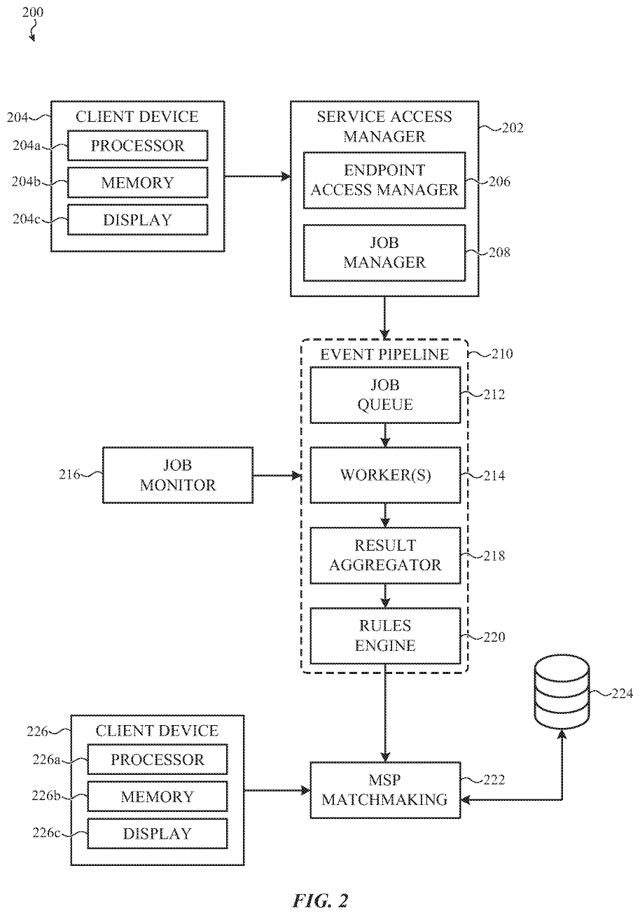

FIG. 2 depicts a system diagram of a system 200 configured to facilitate matchmaking between an organization seeking to engage an MSP for managing one or more third-party software tools and an MSP qualified to manage the one or more third-party software tools.

As with other embodiments described herein, the system 200 includes a service access manager 202 which may be configured to receive command and control instructions from a device operated by an MSP, such as a client device 204. The MSP operating the client device 204 can issue instructions to the service access manager 202 on behalf of an organizational client of the MSP to provision one or more licenses for the organization to one or more third-party software tools, cancel one or more existing licenses to one or more third-party software tools, or obtain usage information about one or more third-party software tools, among other things.

In many cases, the client device 204 can be an electronic device such as the client device 102 of FIG. 1; the client device 204 can include a processor 204a, a memory 204b, and/or a display 204c that are configured to cooperate to instantiate an instance of software configured to receive command and control instructions from a user (MSP) of the client device 204. More simply, the client device 204 can be configured in a similar manner as the client device 102 of FIG. 1, and thus any addition description thereof is not repeated.

Upon receiving an instruction from the client device 204, and/or in response to the occurrence of a scheduled event, the service access manager 202 can be configured to access one or more functions from an endpoint access manager 206. Each retrieved function can thereafter be wrapped, with appropriate arguments, into a job by a job manager 208.

Each job created by the job manager 208 can be added as input to an event pipeline 210, which can include a job queue 212. Job items or work items can be added to and removed from the job queue 212 in any suitable order. One or more worker nodes 214 can be configured to pop jobs from the job queue 212 to execute those jobs/work items against respective third-party APIs. In this manner individual functions, configured with suitable arguments, can be executed in series and/or asynchronously.

In many cases, a job monitor 216 may be configured to monitor execution of each job by each worker node to determine whether the worker nodes 214 execute the jobs successfully. In an event that the job monitor 216 determines that a particular job has failed, the job can be flagged for review by a developer or maintainer. For example, the job monitor 216 may be configured to automatically create an issue in an issue tracking system such that a developer or maintainer is automatically notified of the failed execution.

Once a job successfully executes, results of the execution can be passed to and/or otherwise received by a result aggregator 218. The result aggregator 218 can, in turn, bundle results of execution of one or more jobs as a single structured data object and can provide that structured data object to a rules engine 220, which may apply one or more rules to the structured data (e.g., as data transforms), based on the MSP initiating the job and/or the organization on behalf of which the MSP is acting.

For example, usage data obtained for a particular organization or user by a particular job (scheduled/instructed by an MSP operating the client device 204) from a particular third-party API can be provided as input to the rules engine 220, which may apply one or more MSP or organization specific rules to calculate a cost associated with that determined usage. In other words, different licenses may be negotiated by an MSP on behalf of an organization having different terms; similar usage under different license structures may result in different costs, which may be applied by and/or managed by the rules engine 220.

Output from the rules engine 220 can be provided as input to an invoicing system that can be configured to generate invoices on behalf of the MSP, bundling different costs of a particular organization's use of multiple third-party software tools and creating invoices corresponding to the organization's license structures with respect to the third parties. Thereafter, the MSP may receive, back at the client device 204, an invoice for a particular organization that aggregates, based on usage data obtained by querying (with one or more jobs) each respective third-party software tool licensed by the organization, costs for that particular organization.

An MSP may interact with the service access manager 202 via the client device 204 to obtain licenses for third-party software tools on behalf of an organization, cancel licenses for third-party software tools on behalf of an organization, or obtain usage data about third-party software tools on behalf of an organization. Notably, the event pipeline 210 represents one exemplary way of performing the various tasks that may be performed by the service access manager 202; those skilled in the art will readily appreciate that the same functionality may be performed using any number of different architectures, all of which are contemplated herein.

In many embodiments, the event pipeline 210 can also provide input into an MSP matchmaking system 222. Like the rules engine 220, the MSP matchmaking system 222 can be configured to receive as input usage data corresponding to third-party software tools of a particular organization. In some cases, the MSP matchmaking system 222 can thereafter store the usage data, or information derived from the usage data, in a database 224. The MSP matchmaking system 222 may aggregate the usage data for various organizations to maintain data mapping various organizations to the third-party software tools used by the organizations, the MSPs engaged by the various organizations to support the third-party software tools, and other information about the organizations and/or MSPs.

In one embodiment, the MSP matchmaking system 222 may keep an up-to date list of organizations, the third-party software tools used by the organizations, the MSP managing the third-party software tools on behalf of the organizations, and other information about the organizations and/or MSPs. In other embodiments, the MSP matchmaking system 222 may keep up-to-date training data for a machine learning model based on this information, or may continually update the training of a machine learning model as this information is updated over time. In still other embodiments, this information is more broadly maintained by the service access manager 202 or any other aspect of the access management service discussed herein in the course of providing the functionality described above and accessed by the MSP matchmaking system 222 as necessary to perform the functionality described above.

Regardless of how the above described information is maintained or stored, a client device 226, which may be an electronic device including a processor 226a, a memory 226b, and a display 226c as discussed above, may interact with the MSP matchmaking system 222 to match an organization seeking to engage an MSP for the management of one or more third-party software tools with an MSP suited to manage the third-party software tools. For example, the client device 226 may instantiate an instance of frontend software configured to provide a graphical user interface requesting information about the organization such as a location of the organization, an industry or industries in which the organization operates, a revenue of the organization, a number of employees in the organization, an age of the organization, an information technology budget of the organization, a type or types of electronic devices used by the organization, one or more third-party software tools used by the organization, or any other information. On submission of the information about the organization, the frontend instance may communicate (e.g., via a local or wide-area network such as the Internet) with an instance of backend software instantiated by the MSP matchmaking system 222, providing the information about the organization to the backend instance (e.g., via an HTTP request). On receipt of the information about the organization, the MSP matchmaking system 222 may use the information discussed above (e.g., the information about the third-party software tools used by each of a number of organizations, the MSPs supporting the organizations, the information about the organizations and/or MSPs) to provide an MSP or MSPs (e.g., by selecting one or more MSPs from a larger set of MSPs) suitable for managing the third-party software tools of the organization. Information about the MSP or MSPs may be provided back from the backend instance on the MSP matchmaking system 222 to the client device 226, and subsequently displayed on the client device via the frontend instance.

These foregoing embodiments depicted in FIGS. 1-2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

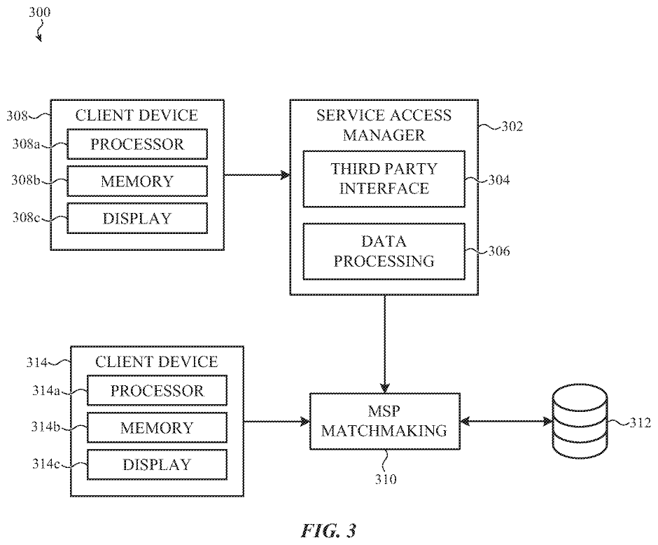

FIG. 3 depicts an alternative architecture for a system 300 to the one described above in FIG. 2 wherein a service access manager 302 includes a third-party interface 304 and a data processor 306.

Similar to that described above, the service access manager 302 may receive command and control instructions from a device operated by an MSP, such as a client device 308. The MSP operating the client device 308 can issue instructions to the service access manager 302 on behalf of an organizational client of the MSP to provision one or more licenses for the organization to one or more third-party software tools, cancel one or more existing licenses to one or more third-party software tools, or obtain usage information about one or more third-party software tools, among other things.

In many cases, the client device 308 can be an electronic device including a processor 308a, a memory 308b, and/or a display 308c, which operate as described above.

Upon receiving an instruction from the client device 308, and/or in response to the occurrence of a scheduled event, the service access manager 302 can be configured to communicate with a third-party service (e.g., a third-party API) to provision licenses, cancel licenses, or obtain usage information. The third-party interface 304 may be responsible for initiating communication with the third-party service (e.g., by formulating a request corresponding to an API standard of the third-party service). In some embodiments, the third-party interface 304 may also provide an interface by which third-party services can communicate with the service access manager 302. For example, the third-party interface 304 may provide one or more API endpoints at which third-party services can report usage information about one or more third-party software tools, among other information, to the service access manager 302. In one specific example, the third-party interface 304 may initiate communication with a third-party service in order to provision one or more licenses of one or more third-party software tools. As part of the request to provision these licenses, a reporting API endpoint may be specified, which the third-party service may communicate with in order to report usage data related to the provisioned licenses.

Information received from third-party services, either as a result of requests initiated by the third-party interface 304 or as a result of information provided by third-party services to the interface not in response to a request may be processed by the data processor 306, which may aggregate, transform, or otherwise operate on the received data in any way to create processed data suitable for downstream usage.

As discussed above, an MSP matchmaking system 310 may receive usage data corresponding to third-party software tools of a particular organization. In some cases, the MSP matchmaking system 310 can thereafter store the usage data, or information derived from the usage data, in a database 312. The MSP matchmaking system 310 may aggregate the usage data for various organizations to maintain data mapping various organizations to the third-party software tools used by the organizations, the MSPs engaged by the various organizations to support the third-party software tools, and other information about the organizations and/or MSPs.

In one embodiment, the MSP matchmaking system 310 may keep an up-to date list of organizations, the third-party software tools used by the organizations, the MSP managing the third-party software tools on behalf of the organizations, and other information about the organizations and/or MSPs. In other embodiments, the MSP matchmaking system 310 may keep up-to-date training data for a machine learning model based on this information, or may continually update the training of a machine learning model as this information is updated over time. In still other embodiments, this information is more broadly maintained by the service access manager 302 or any other aspect of the access management service discussed herein in the course of providing the functionality described above and accessed by the MSP matchmaking system 310 as necessary to perform the functionality described above.

Regardless of how the above described information is maintained or stored, a client device 314, which may be an electronic device including a processor 314a, a memory 314b, and a display 314c as discussed above, may interact with the MSP matchmaking system 310 to match an organization seeking to engage an MSP for the management of one or more third-party software tools with an MSP suited to manage the third-party software tools. For example, the client device 314 may instantiate an instance of frontend software configured to provide a graphical user interface requesting information about the organization such as a location of the organization, an industry or industries in which the organization operates, a revenue of the organization, a number of employees in the organization, an age of the organization, an information technology budget of the organization, a type or types of electronic devices used by the organization, one or more third-party software tools used by the organization, or any other information. On submission of the information about the organization, the frontend instance may communicate (e.g., via a local or wide-area network such as the Internet) with an instance of backend software instantiated by the MSP matchmaking system 310, providing the information about the organization to the backend instance (e.g., via an HTTP request). On receipt of the information about the organization, the MSP matchmaking system 310 may use the information discussed above (e.g., the information about the third-party software tools used by each of a number of organizations, the MSPs supporting the organizations, the information about the organizations and/or MSPs) to provide an MSP or MSPs (e.g., by selecting one or more MSPs from a larger set of MSPs) suitable for managing the third-party software tools of the organization. Information about the MSP or MSPs may be provided back from the backend instance on the MSP matchmaking system 310 to the client device 314, and subsequently displayed on the client device via the frontend instance.

These foregoing embodiments depicted in FIGS. 1-3 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

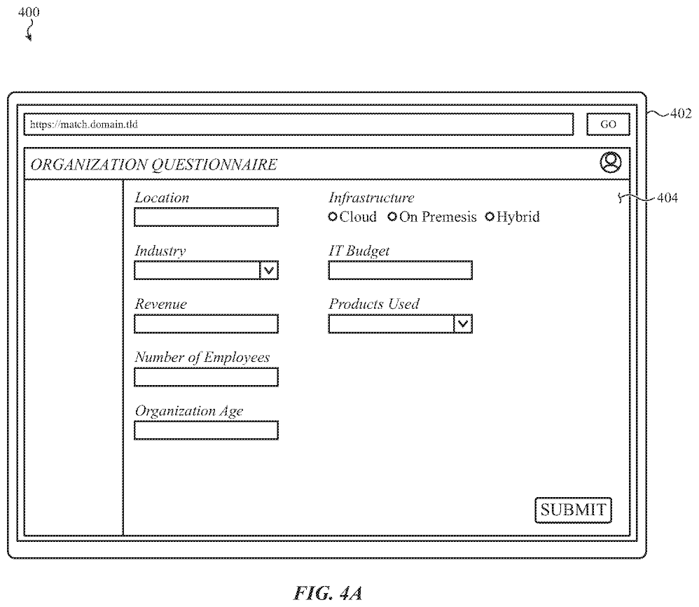

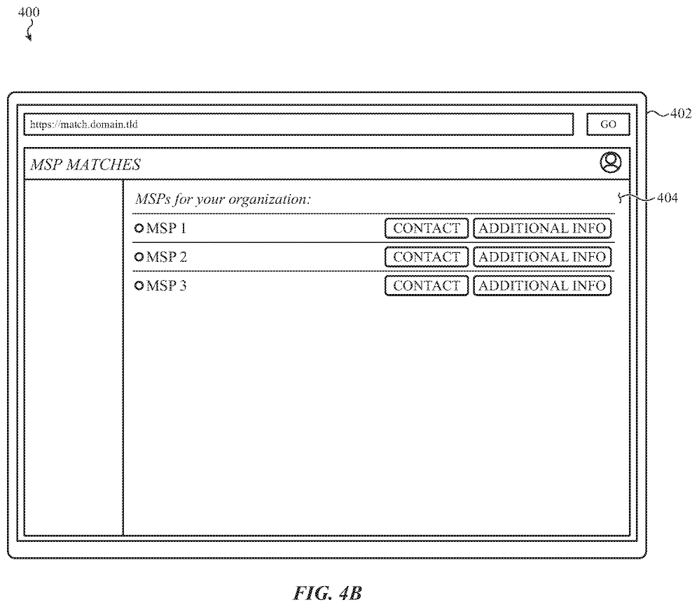

FIG. 4A depicts a client device 400 executing an instance of a client application rendering a graphical user interface of a system configured to facilitate matchmaking between an organization seeking to engage an MSP for the management of one or more third-party software tools and an MSP suitable for managing the one or more third-party software tools.

The client device 400 includes a display 402 that can be operated by an instance of software instantiated by cooperation of a processor and memory (not shown). The instance of software may be referred to as a frontend application, and may cause to be rendered on the display a graphical user interface 404. The graphical user interface 404 can include a content view area in which content associated with the frontend application can be rendered.

The frontend application is configured to interface with and provide command and control instructions to an MSP matching system of an access management service, such as described herein.

In particular, the frontend application can be configured to render one or more graphical user interface elements, which may be interacted with by a user. For example, the frontend application may render a form including fields for providing information about an organization seeking to engage an MSP to manage one or more third-party software tools. The fields may include, for example, inputs allowing a location of the organization, an industry or industries in which the organization operates, a revenue of the organization, a number of employees in the organization, an age of the organization, an information technology budget of the organization, a type or types of electronic devices used by the organization, one or more third-party software tools used by the organization, or any other information to be provided, and a submit button.

An organization seeking to engage an MSP to manage one or more third-party software tools may fill in the various fields and press the submit button. On pressing the submit button, the information about the organization may be sent to a backend instance of software, which may provide, in response, one or more suitable MSPs for managing the one or more third-party software tools. Information about the one or more suitable MSPs may be displayed in an additional graphical user interface discussed below.

The foregoing embodiment depicted in FIG. 4A and the various alternatives thereof and variations thereto are presented, generally, for purposes of explanation, and to facilitate an understanding of various configurations and constructions of a user interface that may be associated with a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that may modifications and variations are possible in view of the above teachings.

FIG. 4B shows the client device 400 including the display 402 rendering a different graphical user interface 404 showing details about one or more MSPs suitable to manage the third-party software tools of the organization that entered the information in the previously discussed graphical user interface. As discussed above, this graphical user interface 404 may be rendered in response to submission of the information about the organization, and in particular in response to a response from a backend instance of software configured to generate the one or more suitable MSPs based on the information about the organization and information collected in the course of operating an access management service as discussed herein. As shown, the graphical user interface 404 may include graphical user interface elements showing one or more MSPs suitable for managing the third-party software tools of the organization, as well as buttons allowing a user to contact each MSP and/or view additional information about each MSP.

The foregoing embodiments depicted in FIGS. 4A-4B and the various alternatives thereof and variations thereto are presented, generally, for purposes of explanation, and to facilitate an understanding of various configurations and constructions of a user interface that may be associated with a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that may modifications and variations are possible in view of the above teachings.

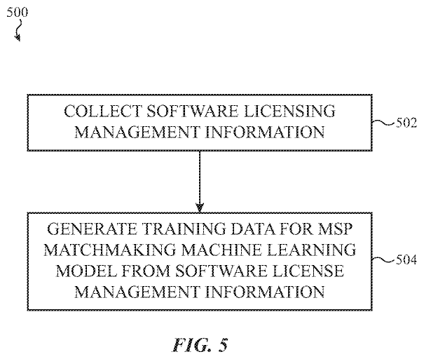

FIG. 5 is a method diagram depicting a flowchart of operations of a method 500 of operating a system for matching an organization seeking an MSP for management of one or more third-party software tools with a suitable MSP for doing so. As with many embodiments, the system may be instantiated by cooperation of a processor, memory, or other suitable infrastructure or combination of interoperating hardware.

The method 500 includes operation 502 at which software licensing management information is collected. As discussed above, the software licensing management information may be collected in the normal course of operating an access management system as described herein, and thus operation 502 may include the operation of an access management system as described herein. As discussed herein, software licensing management information can include any of the aforementioned information collected in the normal course of operating access management as a server, such as, for example, information about one or more MSPs, information about one or more organizations engaging the MSPs for the management of third-party software tools (i.e., customers of the MSPs). The information about the MSPs may include, for example, the customers engaging the MSP, among other information. The information about the customers may include, for example, a location of the organization, an industry or industries in which the organization operates, a revenue of the organization, a number of employees in the organization, an age of the organization, an information technology budget of the organization, one or more types of electronic devices used by the organization, one or more third-party software tools used by the organization, or any other information. This information may be obtained at least in part from one or more third-party APIs associated with the third parties providing the third-party software tools, or may be communicated from the third parties to an interface provided by the access management system discussed herein.

Notably, the software licensing management information may include valuable information about which MSPs are suited to manage third-party software tools on behalf of which organizations. For example, certain MSPs may be better suited to manage organizations of certain sizes or within certain industries, or may have experience managing certain third-party software tools but not others. Normally, organizations seeking to engage an MSP need to expend resources to ensure that a particular MSP can adequately manage the desired third-party software tools thereof. Similarly, MSPs seeking a new customer may need to expend resources to ensure they can meet the demands of the customer. Using the software licensing management information collected in the regular course of the access management system discussed herein may allow organizations to be matched with suitable MSPs with minimal expenditure of resources from both organizations and MSPs.

One exemplary way use to the software licensing management information to match suitable MSPs to organizations is to generate training data for a machine learning model from the software licensing management information, as in operation 504. Generating training data for the machine learning model may be performed in myriad ways as will be appreciate by those skilled in the art. In general, the software licensing management information may be transformed, filtered, or supplemented to generate labeled or unlabeled training data for the machine learning model. In the case of labeled training data, the machine learning model may be a supervised model. In the case of unlabeled training data, the machine learning model may be an unsupervised model. In any case, the training data may be configured to cause the machine learning model, when trained using the training data, to receive information about an organization seeking to engage an MSP to manage third-party software tools for the organization as an input and provide an MSP of a set of MSPs qualified to manage the third-party software tools of the organization as an output. Given that the software licensing management data may include thousands, hundreds of thousands, or more current working relationships between customers and MSPs and information about the types of customers MSPs are currently working with, the machine learning model may accurately predict which MSP of a set of MSPs will be suited to manage the third-party software tools of the organization. In various embodiments, the machine learning model may be configured to provide a number of MSPs from a set of MSPs suitable to manage the third-party software tools of the organization.

As discussed above, the machine learning model may be based on a supervised learning model such as, for example, a support vector machine model, a decision tree model, a random forest model, a neural network or deep neural network, or a naïve Bayes model. The machine learning model may also be based on an unsupervised learning model such as, for example, a k-means model, a Gaussian mixing model, a frequent pattern growth model, or a principal component analysis model. Those skilled in the art will appreciate that myriad machine learning models may be used to provide the functionality discussed above, all of which are contemplated herein.

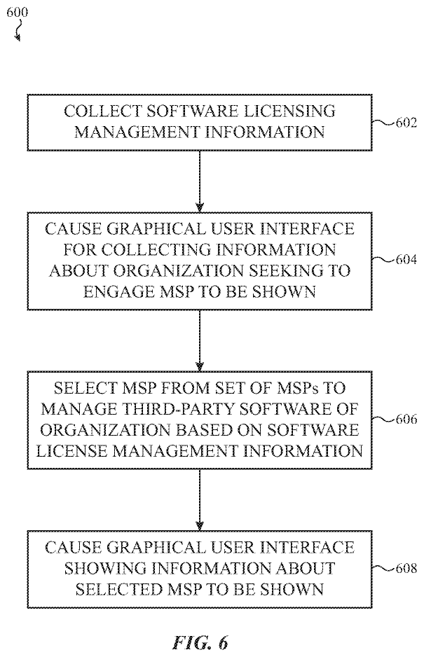

FIG. 6 is another method diagram depicting a flowchart of operations of a method 600 of operating a system for matching an organization seeking an MSP for management of one or more third-party software tools with a suitable MSP for doing so. As with many embodiments, the system may be instantiated by cooperation of a processor, memory, or other suitable infrastructure or combination of interoperating hardware.

The method 600 includes operation 602 at which software licensing management information is collected. As discussed above, the software licensing management information may be collected in the normal course of operating an access management system as described herein, and thus operation 602 may include the operation of an access management system as described herein. In operation 604, a graphical user interface may optionally be caused to display one or more user interface elements for collecting information about an organization seeking to engage an MSP for management of one or more third-party software tools. The graphical user interface may be displayed at a frontend instance of software instantiated at a client device. In response to one or more actions taken in the graphical user interface, the information about the organization may be communicated to a backend instance of software instantiated by one or more physical or virtual computing resources. In response to receipt of the information about the organization, in operation 606 an MSP from a set of MSPs may be selected to manage the third-party software tools of the organization. The MSP may be selected from the set of MSPs based on the software licensing management information, such that the selected MSP is predicted to be qualified to manage the third-party software tools of the organization. In particular, as discussed above, the MSP may be selected from the set of MSPs based on an output form a machine learning model trained using the software licensing management information. In operation 608, the graphical user interface may optionally be caused to display information about the selected MSP. For example, the graphical user interface may show contact information for the MSP, or details about the MSP such as a name of the MSP, a list of customers of the MSP, typical industries of customers of MSPs, or any other information.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

What is claimed is:

1. A server system, comprising:
a memory resource; and
a processing resource operably intercoupled with the memory resource and configured to instantiate an instance of software configured to:
collect and store software licensing management information, the software licensing management information comprising:
information about each of a set of managed service providers; and
information about each of a set of customers of each of the set of managed service providers, the information about each customer of the set of customers comprising a set of third-party software licensed by and deployed by the customer;
generate training data for a machine learning model from the software licensing management information, the training data configured to cause a machine learning model trained using the training data to receive information about an organization seeking to engage a managed service provider to manage third-party software for the organization as input and provide a managed service provider of the set of managed service providers to manage the third-party software for the organization as an output.

2. The server system of claim 1, wherein the software licensing information is collected, at least in part, from one or more third-party application programming interfaces.

3. The server system of claim 1, wherein collecting and storing the software licensing information comprises:
providing an application programming interface endpoint for communication with one or more third-party services; and
receiving at least a portion of the software licensing management information from the one or more third-party services via the application programming interface endpoint.

4. The server system of claim 1, wherein the information about each of the set of customers further comprises one or more of:
a location of the customer;
an industry associated with the customer;
a revenue of the customer;
a number of employees of the customer;
an age of the customer;
an information technology budget of the customer; and
one or more types of electronic devices used by the customer.

5. The server system of claim 1, wherein the information about the organization comprises one or more of:
a location of the organization;
an industry associated with the organization;
a revenue of the organization;
a number of employees of the organization;
an age of the organization;
an information technology budget of the organization;
one or more types of electronic devices used by the organization; and
one or more third-party software products used by the organization.

6. The server system of claim 1, wherein the instance of software is further configured to train the machine learning model using the generated training data.

7. The server system of claim 6, wherein training the machine learning model is unsupervised.

8. The server system of claim 1, wherein the generated training data for the machine learning model is unlabeled.

9. A server system, comprising:
a memory resource; and
a processing resource operably intercoupled with the memory resource and configured to instantiate an instance of software configured to:
collect and store software licensing management information, the software licensing management information comprising:
information about each of a set of managed service providers; and
information about each of a set of customers of each of the set of managed service providers, the information about each customer of the set of customers comprising a set of third-party software licensed by and deployed by the customer;
receive, as input, information about an organization seeking to engage a managed service provider to manage third-party software for the organization; and
select, as an output, a managed service provider of the set of managed service providers to manage the third-party software for the organization, the selected managed service provider being generated as an output from a machine learning model provided the information about the organization as input, the machine learning model being trained at least in part using training data generated from the software licensing management information.

10. The server system of claim 9, wherein the software licensing information is collected, at least in part, from one or more third-party application programming interfaces.

11. The server system of claim 9, wherein collecting and storing the software licensing information comprises:
providing an application programming interface endpoint for communication with one or more third-party services; and
receiving at least a portion of the software licensing information from the one or more third-party services via the application programming interface endpoint.

12. The server system of claim 9, wherein the information about each of the set of customers further comprises one or more of:
a location of the customer;
an industry associated with the customer;
a revenue of the customer;
a number of employees of the customer;
an age of the customer;
an information technology budget of the customer; and
one or more types of electronic devices used by the customer.

13. The server system of claim 9, wherein the information about the organization comprises one or more of:
a location of the organization;
an industry associated with the organization;
a revenue of the organization;
a number of employees of the organization;
an age of the organization;
an information technology budget of the organization;
one or more types of electronic devices used by the organization; and
one or more third-party software products used by the organization.

14. The server system of claim 9, wherein:
the instance of software is a backend application instance configured to communicably couple to a frontend application instance instantiated by a client device communicably coupled to the server system;
the information about the organization is received from the frontend application instance; and
the selected MSP is provided to the frontend application instance to cause the frontend application instance to display, in a graphical user interface thereof, information about the managed service provider of the set of managed service providers to manage the third-party software of the organization.

15. A method for matching an organization to a managed service provider, the method comprising:
collecting and storing software licensing management information, the software licensing management information comprising:
information about each of a set of managed service providers; and
information about each of a set of customers of each of the set of managed service providers, the information about each customer of the set of customers comprising a set of third party software licensed by and deployed by the customer;
receiving from a frontend instance of software instantiated at a client device, at a backend instance of software instantiated by cooperation of processing resources and memory resources, a request comprising information about an organization seeking to engage a managed service provider for management of third-party software for the organization;
in response to the request, generating a response to the request, the response comprising a selected managed service provider of the set of managed service providers for managing the third-party software of the organization, the selected managed service provider being generated as an output from a machine learning model provided the information about the organization as input, the machine learning model being trained at least in part using training data generated from the software licensing management information; and
transmitting the response to the frontend instance to cause a graphical user interface of the frontend instance to display information about the selected managed service provider.

16. The method of claim 15, wherein the software licensing information is collected, at least in part, from one or more third-party application programming interfaces.

17. The server system of claim 15, wherein collecting and storing the software licensing information comprises:
providing an application programming interface endpoint for communication with one or more third-party services; and
receiving at least a portion of the software licensing information from the one or more third-party services via the application programming interface endpoint.

18. The method of claim 15, wherein the information about each of the set of customers further comprises one or more of:
a location of the customer;
an industry associated with the customer;
a revenue of the customer;
a number of employees of the customer;
an age of the customer;
an information technology budget of the customer; and
one or more types of electronic devices used by the customer.

19. The method of claim 15, wherein the information about the organization comprises one or more of:
a location of the organization;
an industry associated with the organization;
a revenue of the organization;
a number of employees of the organization;
an age of the organization;
an information technology budget of the organization;
one or more types of electronic devices used by the organization; and
one or more third-party software products used by the organization.

20. The method of claim 15, further comprising causing the graphical user interface of the frontend instance to display one or more graphical user elements for collecting the information about the organization and for initiating communication of the information about the organization to the backend instance.
